(19) United States
(12) Patent Application Publication
(10) Pub. No.: US 2005/0074389 A1
(43) Pub. Date: Apr. 7, 2005

(54) Method for the production of highly pure nitric acid

(76) Inventors: Paul Hofmann, Bad Durkheim (DE); Franz Josef Sanden, Ludwigshafen (DE); Walter Dorflinger, Ostringen (DE)

Correspondence Address: KEIL & WEINKAUF, 1350 CONNECTICUT AVENUE, N.W., WASHINGTON, DC, 20036, US

(21) Appl. No.: 10/473,212

(22) PCT Filed: Mar. 27, 2002
(86) PCT No.: PCT/EP02/03422

(30) Foreign Application Priority Data
Apr. 12, 2001 (DE) 101 18 383.6

(51) Int. Cl. C01B 21/44

(52) U.S. Cl. 423/394.2

(57) ABSTRACT

In a new and improved process for preparing high-purity nitric acid by distillation or rectification of nitric acid, crude nitric acid or mixtures thereof in a column, 85-95% strength by weight nitric acid, crude nitric acid or a mixture thereof is distilled at from 70 to 110° C. and a pressure of from 0.1 to 2 bar.

The present invention relates to a process for preparing high-purity nitric acid by distillation or rectification of nitric acid, crude nitric acid or mixtures thereof in a column, wherein from 85 to 95% strength by weight nitric acid, crude nitric acid or a mixture thereof is distilled at from 70 to 110° C. and a pressure of from 0.1 to 2 bar.

SU-A-11 01 249 discloses a process for preparing high-purity nitric acid from 60% strength crude nitric acid by means of a complicated multiple distillation.

This process has the disadvantage that cations such as calcium, magnesium, sodium and zinc occur as impurities in concentrations of more than 1 ppm.

It is an object of the present invention to remedy the abovementioned disadvantages.

We have found that this object is achieved by a new and improved process for preparing high-purity nitric acid by distillation or rectification of nitric acid, crude nitric acid or mixtures thereof in a column, wherein from 85 to 95% strength by weight nitric acid, crude nitric acid or a mixture thereof is distilled at from 70 to 110° C. and a pressure of from 0.1 to 2 bar.

The process of the present invention can be carried out as follows:

The high-purity nitric acid can be obtained by batchwise or preferably continuous distillation, preferably rectification, of from 85 to 95% strength by weight nitric acid, crude nitric acid or mixtures thereof at from 70 to 115° C., preferably from 75 to 100° C., particularly preferably from 80 to 90° C., at atmospheric pressure or under slightly superatmospheric or subatmospheric pressure, i.e. in the range from 0.1 to 2 bar, preferably from 0.5 to 1.5 bar, particularly preferably at atmospheric pressure. The temperature at the bottom of the distillation column is generally from 100 to 140° C., preferably from 110 to 130° C., particularly preferably from 115 to 125° C.

In this process, from 85 to 95% strength by weight nitric acid, crude nitric acid or a mixture thereof can be fed directly into the bottom of the column or can be fed at any point on the column or, preferably, highly concentrated crude nitric acid is used and a diluent is fed in at any point on the column so that the concentration of the nitric acid to be purified is from 85 to 95% by weight after this addition. This 85-95% strength by weight nitric acid, crude nitric acid or mixture thereof subsequently passes through from one to five, preferably from one to three, particularly preferably from one to two, theoretical plates. In general, the feed stream can be at ambient temperature, but it is advantageous to heat the feed stream to, as a rule, from 40 to 90° C., preferably to from 70 to 90° C., more preferably to from 75 to 85° C. and particularly preferably to from 78 to 82° C.

Highly concentrated nitric acid, crude nitric acid and mixtures thereof contain from 95 to 100% by weight, preferably from 96 to 99% by weight, particularly preferably from 97 to 98% by weight, of nitric acid and are generally obtainable by customary methods, for example by reaction of NOₓ and water in an autoclave or from the reaction of NOₓ and water and concentration by means of azeotropic distillation after addition of sulfuric acid.

The high-purity nitric acid produced according to the present invention generally contains from 0.005 to 0.1 [mg/kg] of sulfate, preferably from 0.01 to 0.09 [mg/kg] of sulfate, particularly preferably from 0.02 to 0.08 [mg/kg] of sulfate, generally from 0.005 to 0.1 [mg/kg] of chloride, preferably from 0.01 to 0.09 [mg/kg] of chloride, particularly preferably from 0.02 to 0.08 [mg/kg] of chloride, and from 0.05 to 1 [ppb] of sodium, preferably from 0.07 to 0.8 [ppb] of sodium, particularly preferably from 0.09 to 0.5 [ppb] of sodium, in particular from 0.1 to 0.3 [ppb] of sodium, and in addition impurities in concentrations of 0.1 ppb by weight (ppb=parts per billion) or less per cation (with the exception of H⁺). Thus, the chromium content is generally from 0.001 to 0.09 [ppb], preferably from 0.005 to 0.07 [ppb], particularly preferably from 0.007 to 0.05 [ppb]. The calcium content is generally from 0.005 to 0.1 [ppb], preferably from 0.01 to 0.09 [ppb], particularly preferably from 0.015 to 0.07 [ppb]. The potassium content is generally from 0.005 to 0.1 [ppb], preferably from 0.01 to 0.09 [ppb], particularly preferably from 0.015 to 0.07 [ppb]. The iron content is generally from 0.005 to 0.1 [ppb], preferably from 0.01 to 0.09 [ppb], particularly preferably from 0.015 to 0.07 [ppb]. The magnesium content is generally from 0.001 to 0.09 [ppb], preferably from 0.005 to 0.07 [ppb], particularly preferably from 0.007 to 0.05 [ppb]. The zinc content is generally from 0.005 to 0.1 [ppb], preferably from 0.01 to 0.09 [ppb], particularly preferably from 0.015 to 0.07 [ppb]. The copper content is generally from 0.005 to 0.1 [ppb], preferably from 0.01 to 0.09 [ppb], particularly preferably from 0.015 to 0.07 [ppb]. The manganese content is generally from 0.005 to 0.1 [ppb], preferably from 0.008 to 0.09 [ppb], particularly preferably from 0.01 to 0.07 [ppb]. The aluminum content is generally from 0.005 to 0.1 [ppb], preferably from 0.01 to 0.09 [ppb], particularly preferably from 0.02 to 0.08 [ppb].

Suitable diluents for adjusting the concentration of the nitric acid, crude nitric acid or mixtures thereof to from 85 to 95% by weight include water, which is preferably used in the deionized form, and also dilute nitric acid, crude nitric acid or mixtures thereof, generally 5-95% strength by weight, preferably 50-95% strength by weight, particularly preferably 60-95% strength by weight, nitric acid, crude nitric acid or mixtures thereof, aqueous inorganic solutions such as dilute salt solutions, aqueous organic solutions such as alcohols or alkalis. It is likewise possible to mix highly concentrated nitric acid, crude nitric acid or a mixture thereof with water-containing solutions in the column, instead of mixing them in the feed stream.

The entire column and its associated apparatuses above the bottom of the column generally consist of nonmetallic components, preferably of glass or heat-resistant plastic such as highly fluorinated materials, for example Teflon, which is preferably employed as lining. Particular preference is given to using borosilicate glass. The vaporizer can contain heating rods of, for example, tantalum.

The column preferably consists of two or more, e.g. from two to twelve, preferably from three to ten, particularly preferably from four to nine, in particular from five to eight, sections. Each of the lower sections is generally provided with a support grating which supports the column packing. The packing of the column can consist either of a bed of packing elements or of a structured packing made of glass, Teflon or mixtures thereof. Such columns generally have from one or two to twelve, preferably from three to ten, particularly preferably from four to nine, in particular from five to eight, theoretical plates. Suitable packing elements are all known packing elements or mixtures thereof, for example Raschig rings, Pall rings, Berl saddles or Prym rings.

Above the column, a condenser, e.g. a shell-and-tube heat exchanger which is made of glass and is operated using cooling water or, if desired, another coolant, can cool the high-purity nitric acid prepared according to the present invention. Part of the purified product can be returned to the column.

### EXAMPLES

### Example 1

High-concentration, 95-100% strength by weight crude nitric acid was placed in the bottom of a column which was made of borosilicate glass, had a ratio of column height to column diameter of 3:1, consisted of 6 glass sections packed with glass Raschig rings (diameter: 25 mm) on a support grating, was provided with a vaporizer fitted with tantalum heating rods and had an inlet for the feed between the 2nd and 3rd glass section, and 75-95% strength by weight crude nitric acid was introduced through the feed inlet so as to give a nitric acid concentration of from 85 to 95% by weight. A reflux ratio of 0.4 and a concentration of nitric acid taken off at the top of from 98.5 to 99.5% by weight were set. The temperature at the bottom was 120-125° C. and the temperature at the top was 82 to 84° C. A high-purity nitric acid meeting the following specification was obtained:

| Cation | Concentration [ppb] |
|---|---|
| Sodium | 0.18 |
| Chromium | <0.01 |
| Calcium | 0.04 |
| Potassium | 0.03 |
| Iron | 0.04 |
| Magnesium | <0.01 |
| Zinc | 0.03 |
| Copper | 0.02 |
| Manganese | 0.02 |
| Aluminum | 0.06 |
| Anion | [mg/kg] |
| Sulfate | <0.05 |
| Chloride | <0.05 |

1. A process for preparing high-purity nitric acid by distillation or rectification of nitric acid, crude nitric acid or mixtures thereof in a column, wherein from 85 to 95% strength by weight nitric acid, crude nitric acid or a mixture thereof is distilled at from 70 to 115° C. and a pressure of from 0.1 to 2 bar and nonmetallic components are used as column material.

2. A process for preparing high-purity nitric acid as claimed in claim 1, wherein the distillation or rectification column is operated at atmospheric pressure.

3. A process for preparing high-purity nitric acid as claimed in claim 1, wherein the distillation or rectification column contains at least three theoretical plates.

4. A process for preparing high-purity nitric acid as claimed in claim 1, wherein the distillation or rectification column contains at least four theoretical plates.

5. A process for preparing high-purity nitric acid as claimed in claim 1, wherein from 85 to 95% strength by weight nitric acid, crude nitric acid or a mixture thereof is placed in the bottom of the column or fed in at any point of the column, with the proviso that from one to five theoretical plates are located above the feed point.

6. A process for preparing high-purity nitric acid as claimed in claim 1, wherein highly concentrated nitric acid, crude nitric acid or a mixture thereof is placed in the bottom of the column and the concentration is adjusted to from 85 to 95% by weight by means of a diluent introduced via a feed stream and this 85-95% strength by weight nitric acid, crude nitric acid or a mixture thereof is subsequently passed through from one to five theoretical plates.

7. A process for preparing high-purity nitric acid as claimed in claim 1, wherein highly concentrated nitric acid, crude nitric acid or a mixture thereof is placed in the bottom of the column and the concentration is adjusted to from 85 to 95% by weight by means of a diluent introduced via a feed stream and this 85-95% strength by weight nitric acid, crude nitric acid or a mixture thereof is subsequently passed through from one to three theoretical plates.

8. A process for preparing high-purity nitric acid as claimed in claim 6, wherein the diluent used is water, dilute nitric acid, an aqueous inorganic or organic solution or a mixture thereof.

9. A process for preparing high-purity nitric acid as claimed in claim 1, wherein the feed stream is heated to from 40 to 90° C.
